(19) United States
(12) Patent Application Publication
(10) Pub. No.: US 2006/0070488 A1
(43) Pub. Date: Apr. 6, 2006

(54) Propellantless propulsion engine

(76) Inventor: Harold Ariel Tavarez, Long Beach, CA (US)

Correspondence Address: Harold Tavarez, 2501 East 4th Street #2, Long Beach, CA, 90814, US

(21) Appl. No.: 10/951,946

(22) Filed: Sep. 28, 2004

(51) Int. Cl. F16F 15/22

(52) U.S. Cl. 74/570.1

(57) ABSTRACT

An inertial thrust engine (10) includes a housing (12), a cover plate (14), an eccentrically disposed elliptical chamber (16), and a weighted rotor (18). The rotor (18) has a plurality of orbital channels (20a-20d) on one face of the rotor. The rotor (18) is keyed for rotation on a central shaft (22). A rotary weight (24) couples with the weighted rotor (18) and is kept in an eccentrically disposed position on the rotor (18) by the chamber (16). The rotor (18) conveys rotary energy to the weight (24) loaded on the rotor (18) to gyrate together about a central axis (28), producing an unbalanced centrifugal force directed as a propellantless propulsion force (32).

### BACKGROUND

1. Field of Invention

The present invention employs a weighted rotor producing an unbalanced centrifugal force for propellantless propulsion.

2. Description of Prior Art

In a more general and wider scope, to produce thrust, the existing propulsion technology depends on the acceleration of a propellant. In jet propulsion, a jet engine accelerates a mass of air from the atmosphere, or a mass of water in a marine environment. Similarly, a propeller accelerates either a mass of air or a mass of water. In rocket propulsion, a rocket engine also accelerates the mass of a propellant. In electric, plasma and ion propulsion engines, either atomic particles or molecules are used as a propellant. As dominant and useful the present propulsion technology is; all the current propulsion technology engines have many severe disadvantages and limitations found in the inherent dependence on the propellant available for thrust.

In a more specific and narrower scope; in the field of propulsion, one area working to achieve propellantless thrust is the field of invention that make use of the centrifugal forces produced with gyrating masses. By spinning a mass about a center of revolution, considerable amounts of centrifugal forces can be developed. The ensuing centrifugal forces are specifically useful as a source of thrust for propellantless propulsion. Several devices and methods have been proposed. One of the proposed methods consists of a mass exchange between counter rotating arms to produce a directed and unbalanced centrifugal force on one side of the device. Another method consists of varying the radius of gyration of sets of discrete masses gyrating about a center of revolution. Various mechanisms employing these means and methods of propulsion have been proposed. However, all the proposed means and methods for the production of unidirectional and unbalanced centrifugal forces also have many serious disadvantages and limitations. The machines produced by the proposed techniques are exceedingly complex and unreliable mechanisms. They require complex mechanisms for the rotation of the multiplicity of weighted arms and masses that generate the unbalanced centrifugal forces. Moreover, all the proposed machines fail to generate a directionally continuous thrust of a constant magnitude. At best, all what the proposed prior art machines can do is produce a discontinuous impulse of thrust in an unreliable operation that includes unwanted vibrations. The discontinuous impulses of thrust produced are predetermined by the degree of separation between the multiplicity of weighted arms and masses that generate the unbalanced centrifugal forces. As a result, the propulsion devices proposed by the prior art are limited to the production of impulses of thrust of time varying magnitude during a cycle of revolution. In addition, these very same devices have yet to find any practical, useful, and successful commercial and military application in the field of propulsion.

### SUMMARY OF THE INVENTION

The present invention is a prime mover producing a directed and unbalanced centrifugal force with a weighted rotor. The invention comprises a rotary weight placed eccentrically on a weighted rotor, a single or a plurality of orbit defining annular channels at equidistant radial distances from the center of the rotor, and an eccentrically disposed elliptical chamber. The elliptical chamber supports the uniform rotary motion of the eccentrically disposed weight riding on the rotor. The weighted rotor gyrates about a central axis to produce centrifugal forces available for propulsion. The invention is useful as a prime mover for the propulsion of railway cars, passenger cars, trucks, buses, service utility vehicles, aviation, sailing ships and submarines, spaceships for space travel, satellites, and the like.

### BRIEF DESCRIPTION OF THE DRAWINGS

FIG. 1 shows a top plan view of an inertial thrust engine.

FIG. 2 is a cross sectional side view of the inertial thrust engine shown in FIG. 1.

FIG. 3 is a top plan view of an improved embodiment of an inertial thrust engine.

FIG. 4 is a side view of the inertial thrust engine shown in FIG. 3.

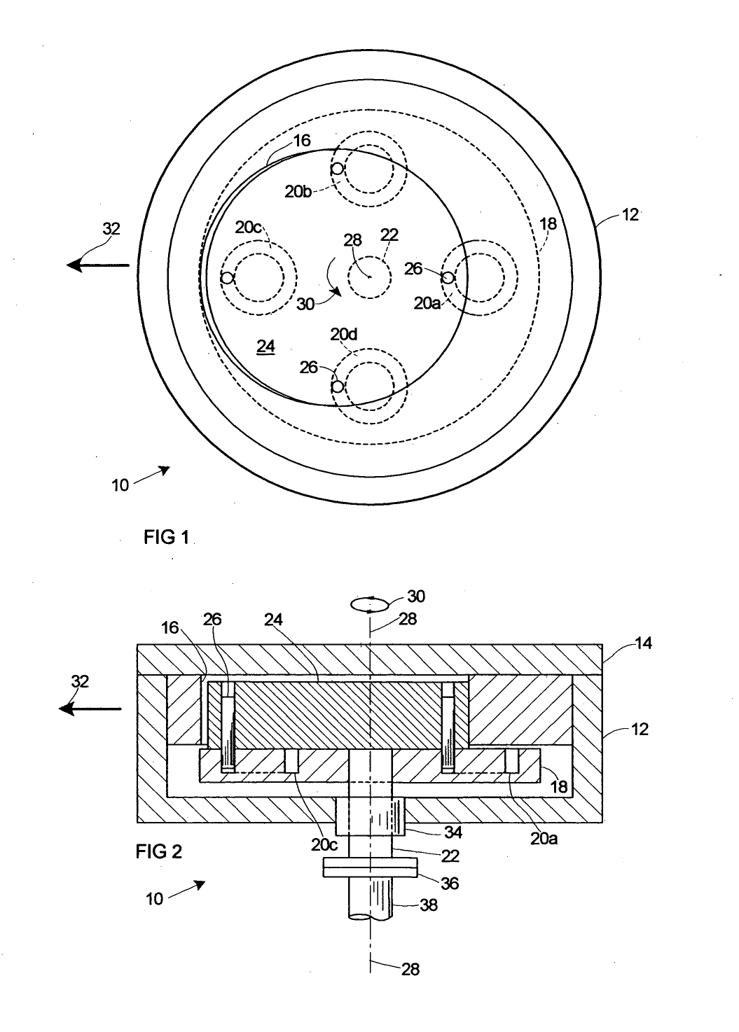

### FIG. 1 and FIG. 2—PREFERRED EMBODIMENT

FIG. 1 shows a top plan view of a propellantless inertial thrust engine 10 built in accordance with the principles of the invention. FIG. 2 shows the side view cross section of the inertial thrust engine 10 shown in FIG. 1. Referring to both FIG. 1 and 2, the inertial thrust engine 10 has a housing 12 with a cover plate 14 to enclose within the propulsive thrust producing members. In the housing 12, therein is an eccentrically disposed elliptical chamber 16. Adjacent to the chamber 16 appears a weighted rotor 18 with four orbital channels 20a-20d. The channels 20a-20d are equally spaced 90° apart at identical radial distances from the center of the rotor 18. The rotor 18 is keyed to a central shaft 22 for rotation. A rotary weight 24 with a plurality of pins 26 couples with and rides on the rotor 18. The chamber 16 maintains the weight 24 in an eccentrically disposed position on the rotor 18. Each pin 26 has the suitable dimensions to project and slide with relative ease inside a corresponding annular shaped channel 20a-20d. A central axis 28 defines the center of rotation about which the rotor 18 and the weight 24 gyrate together as one unit in the housing 14. An arrow 30 indicates the direction of rotation for the rotary components. Another arrow indicates the direction of a propulsion force 32 created with an unbalanced centrifugal force produced by the unitary rotation of the weight 24 riding on the rotor 18. The shaft 22 is journaled for rotation in a bearing 34 and couple with a transmission 36. The transmission 36 couple with a drive shaft 38. The drive shaft 38 belongs to the motor of the vehicle (not shown) to which the engine 10 is attached. The shaft 38 conveys a torque from a motor (not shown) for the rotation of the rotor 18. The weighted rotor 18 couple with the weight 24 and gyrates about a central axis 28 in the direction of rotation 30 to produce an unbalanced centrifugal force. An unbalanced centrifugal force is a propellantless force since no mass is ejected to the environment to produce it; therefore, the propulsion force 32 is also a propellantless force since no mass is ejected in the environment to produce it. In addition, the propellantless propulsion force 32 is also a linear force. The motion of the vehicle on which the propulsion engine 10 is attached occurs in the direction of the propellantless propulsion force 32. In the inertial thrust engine 10, the rotary motion of the eccentrically disposed weight 24 spin together with the rotor 18 to produce an unbalanced centrifugal force in one direction. With the weighted rotary platform in the invention, the weight 24 riding on the rotor 18, the inertial thrust engine 10 generates an unbalanced centrifugal force by way of the functional cooperation that exists between the eccentrically disposed chamber 16, the rotor 18, and the weight 24. The rotor 18 is centered on the axis 28. The chamber 16 maintains a major portion of the weight 24 in an eccentrically shifted position on the rotor 18. Some of the mass in the weight 24 shifts more toward one side of the rotor 18 than the other. The eccentrically disposed weight 24 rides on the rotor 18 in contact with one side of the chamber 16 and gyrate about the central axis 28. In a cycle of revolution, the side of the weight 24 in transit through the minimum radius of gyration sector comes in contact with the chamber 16. Both, FIGS. 1 and 2 shows the eccentrically disposed placement of the weight 24 on the rotor 18. The drawings also show the relative mass quantity of the weight 24 on either side of the axis 28. Relative to the axis 28, more of the mass in the weight 24 rides on one side of the rotor 18 than on the other. The shifted mass produces an unbalanced mass loading on the rotor 18 that generate the unbalanced centrifugal force that defines the propellantless propulsion force 32. During a cycle of revolution, the eccentrically disposed weight 24 spins and maintain a uniform rotary motion about the axis 28 by the coupling between the pins 26 with the channels 20a-20d. Each individual pin 26 projects and slides inside a corresponding channel 20a-20d. As both the weighted rotor 18 and the weight 24 gyrate together about the axis 28; each corresponding pin 26 slides and shift position inside its corresponding channel 20a-20d in order to maintain the uniform rotary motion of the eccentrically driven weight 24. The annular shape of each channel 22a-22d contain all the angular positions a pin 26 will occupy in transit as the eccentrically driven weight 24 revolves about the axis 28 during a cycle of revolution. With respect to the center of the weight 24, the axis 28 is in a position other than the weight 24 own center.

As an example of the functional cooperation between the channels 20a-20d and the eccentrically disposed weight 24, consider the following case in point. If a disk shaped body with a uniform distribution of mass and shape spin about its own geometric center; the disk will revolve with a uniform rotary motion and all the centrifugal forces produced are equally balanced and evenly distributed in the disk plane of rotation. In contrast, if the same disk were to rotate about an eccentric axis, an axis away from the center of the disk, the disk will generate a host of unbalanced centrifugal forces unevenly distributed in the plane of rotation. The disk rotation about the eccentric axis produces a simultaneous spin about the axis of rotation that will include the motion of two opposing lobes of masses, a major lobe and a minor one. In reference to the off-center axis of rotation, the disk is comparable to a weighted rotor. On one side of the disk, from the eccentric axis of rotation to the point with the largest radius on the disk, that region is defined by major lobe; a large volume of mass that includes a most of the mass in the disk. That side with the oversize lobe generates the larger centrifugal force. On the opposing side, the lesser amount of mass, area and volume defines the minor lobe. Correspondingly, the radius of gyration in the minor lobe is also smaller in comparison. Accordingly, the magnitude of the centrifugal force produced by the minor lobe is also smaller. The rotary motion of the two lobes with the uneven distribution of mass and volume is non uniform. In a cycle of revolution, the major lobe spins in a larger radius of gyration as it revolves about the-off-center axis of rotation. The major lobe continuously changes angular positions as the lobe gyrates about the axis of rotation. In one cycle of revolution, the major lobe changes angular position as it spins 360° about its own off-center axis; followed by a similar angular change in the minor lobe. For the rotary weight 24 spinning about an eccentric axis of rotation, the channels 20a-20d facilitate the uniform gyratory motion about the axis 28. For the weight 24, the axis 28 is an eccentric axis of gyration. The channels 20a-20d maintain the weight 24 in an even and uniform rotation by acting as a damper to even out and assist the angular motion as the weight 24 gyrates about the axis 28. As the rotor 18 spin; each corresponding channel 20a-20d also travel in the same direction of rotation 30. In one cycle of revolution, the rotor 18 completes one cycle of revolution about the axis 28, and each of the channels 20a-20d also complete one cycle of revolution about a pin 26. A pin 26 slides and travels in its corresponding channel 20a-20d by continuously altering its angular position within the corresponding annular channel 20a-20d. The circular shape of each of the orbital channels 22a-22d contain all the angular positions a pin 26 will occupy in transit as the weight 24 shifts and rotates to maintain a uniform rotary motion during a cycle of revolution. Thus during a cycle of revolution, the weight 24, in contact with the eccentric chamber 16 maintains an eccentrically disposed position of uniform rotary motion as it gyrates with the rotor 18. As the weight 24 rides on the weighted rotor 18, the channels 20a-20d aid in maintaining a larger amount of the mass in the weight 24 (the major lobe) pointing in the same direction to produce a directed and unbalanced centrifugal force also pointing in the same direction. The orbital channels 22a-22d facilitate the even transition of mass from an orbit of low radius to an orbit of high radius of gyration and vice versa. As a result of the functional cooperation between the chamber 16, the weighted rotor 18, and the channels 20a-20d, the overload of the weight 24 mass on one side of the rotor 18 generates an unbalanced centrifugal force directed towards the side of the weight 24 with the larger radius of gyration. The direction of the unbalanced centrifugal force is in the direction of the propulsion force 32.

For a circular disk of constant mass and shape rotating about its own center at a constant frequency, the particles in the disk will also spin with the same frequency. All the particles in the disk also complete the same number of revolutions or cycles per second. However, the magnitude of the centrifugal force for particles in the disk will vary. The magnitude of a centrifugal force depends on the mass of the particle, the square of the frequency or the square of the particle lineal velocity, and the radius of gyration from the center of the disk. For a particle of mass farther away from the center, the magnitude of the centrifugal force produced will be much greater than the magnitude of the centrifugal force produced by a particle closer to the center of the disk. The larger the radius of gyration, the larger the magnitude of the centrifugal force produced; and similarly, the smaller the radius of gyration, the smaller the magnitude of the centrifugal force. In general, the magnitude of the centrifugal force produced by a particle with a large radius of gyration is greater than the magnitude of the centrifugal force produced by a particle in a lesser radius of gyration. This fundamental principle of centrifugal force development also applies to the operation of the eccentrically disposed weight 24 loaded on the rotor 18 as they gyrate together about the axis 28.

In the inertial thrust engine 10, the eccentrically disposed weight 24, couple with the rotor 18 produces an unbalanced centrifugal force in one direction by way of a changing radius of gyration in predetermined sectors at predetermined moments in a cycle of revolution. The path of rotation followed by particles of mass in the weight 24 contain certain predetermined sectors on which particles attain a maximum radial distance from the axis of rotation and then, after traveling 180° more, attain a minimum radial distance. The position of the predetermined sector in which particles of mass attain a maximum radial distance corresponds to the position of maximum centrifugal force, and accordingly, also the direction of the propulsion force 32. The position of the predetermined sector in which particles attain a minimum radial distance corresponds to the position of minimum centrifugal force; in a direction opposed to the direction of the maximum centrifugal force, and correspondingly, the direction opposed to the direction of the propulsion force 32. The orbital path of mass of particles in the eccentrically disposed weight 24 is arranged in such a manner that at the predetermined sector of maximum radius of gyration, those particles are either positioned at, or just approaching, or just leaving the maximum radius of gyration predetermined sector, and at that given moment, are producing maximum centrifugal force components in the desired direction, the direction of the propulsion force 32. Other particles of mass in the opposite side, are either positioned at, or just approaching, or just leaving the predetermined sector of minimum radius of gyration, and at that moment, are producing minimum centrifugal force components opposing the direction of the maximum centrifugal force; this resulting in an unbalanced centrifugal force in the direction of the maximum radius of gyration predetermined sector, in the direction of the propulsion force 32.

Referring to FIG. 1, pin 26 in the channel 22a, is positioned in the predetermined sector of minimum radius of gyration with surrounding particles of mass in the weight 24 also in the same sector; and neighboring particles of mass also just approaching, or just leaving the predetermined sector of minimum radius of gyration. At that given moment, particles of mass in the weight 24 are producing components of centrifugal force of a lesser magnitude in the direction of the minimum radius of gyration, in opposition to the direction of the propulsion force 32. In the opposite side, another pin 26 in the channel 22c, and surrounding particles of mass in the weight 24 are positioned at in the predetermined sector of maximum radius of gyration; with neighboring mass particles also just approaching, or just leaving the predetermined sector of maximum radius of gyration. In the maximum radius of gyration sector, large centrifugal force components are produced in the direction of the maximum radius of gyration, and consequently, in the direction of the propulsion force 32. The other two pins 26 in the channels 20b and 20d are in transition between the predetermined sectors of maximum and minimum radius of gyration; while at the same time transferring the weight 24 a large angular momentum component push in the direction of rotation 30. Preferably, the weight 24 should be a disk shaped mass with a continuous and constant distribution of mass to facilitate the production of a continuous propulsion force 32 of a constant magnitude and direction. This requirement also takes into account the mass of the pins 26 and adjusts accordingly. By this method of operation, the differential in magnitudes between the maximum centrifugal force and the lesser centrifugal force components in opposition to each other results in an unbalanced centrifugal force directed as the propellantless propulsion force 32.

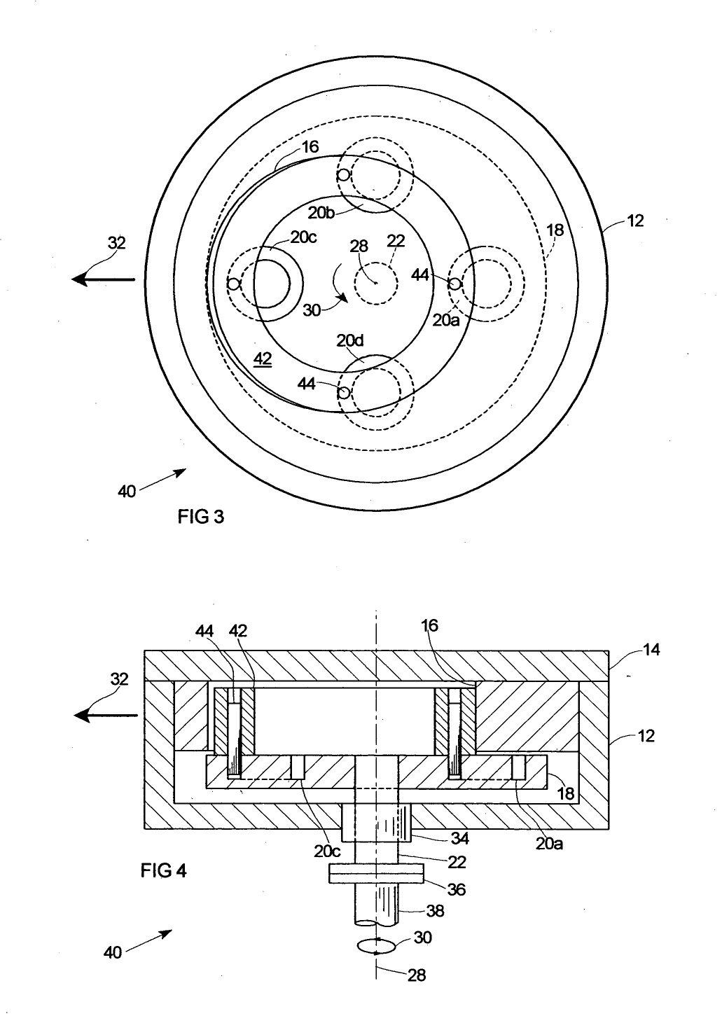

### FIG. 3 and FIG. 4

FIG. 3 is a top view of an improved the inertial thrust engine 40. FIG. 4 is a side view of FIG. 3. The inertial thrust engine 10 has been improved by substituting the disk shaped weight 24 with a rotary annular weight 42. The weight 42 has a plurality of pins 44. Each pin 44 projects into a corresponding orbital channel 22a-22d in the rotor 18. In FIG. 3 and FIG. 4, all the previous members in the engine 10 are shown with the same corresponding numerals. Only the new components added to create the thrust engine 40 are shown with new part numbers. The operation of the thrust engine 40 is also similar to the operation of the thrust engine 10. Instead of the disk shaped weight 24, the thrust engine 40 employs the annular weight 42 to generate the unbalanced centrifugal force that produces the propellantless propulsion force 32.

### CONCLUSION, RAMIFICATIONS, AND SCOPE OF INVENTION

As the reader can see from the description above, the inertial thrust engine is a novel and useful propellantless prime mover. Propellantless propulsion is the propulsion technology of the twenty-first century. The above description contains specificities and descriptions that should not be construed as limits on the scope and range of the innovation; but rather as an exemplification of presently preferred embodiments. There are additional combinations of embodiments. For example, in the eccentrically disposed elliptical chamber shown in the embodiments herein, the chamber is set in contact with the minimum radius of gyration sector. However, another alternative would be to make use of an eccentrically disposed circular chamber in contact with part of, or the entire rotary weight circumference. Another embodiment is to employ a single bearing around the rotary weight, or a plurality of bearings also around the rotary weight as a substitute for the chamber.

In another embodiment, a bearing in the engine housing around the perimeter of the weighted rotor, or a plurality of bearings also around the weighted rotor may be employed to serve as a thrust absorbing member and simultaneously provide additional rotor support.

In another embodiment, a second eccentric weight may be added to the weighted rotor in order to augment the total thrust output of the rotor. Referring to FIG. 2 as an example, after an adjustment to add volume to the engine housing, a second eccentric weight with the necessary orbital channels may be added to the rotor, and an additional or a modified eccentrically disposed chamber may be added on the other side of the weighted rotor to augment the weighted rotor total centrifugal thrust output. The dual eccentric weights will augment the total propulsion thrust output of the entire engine.

In another embodiment, a rotary weight with suitable pins may be sandwiched in between two weighted rotors. For example, in both FIG. 2 and FIG. 4, another shaft journaled for rotation on a bearing attached to plate 14 for support may be added. The second weighted rotor will provide additional functional support for the rotary weight. With the same approach, the thrust engine shown in FIG. 4 may be modified by including a shaft of suitable length to accept a second weighted rotor. A second bearing may also be added on the housing cover plate to provide additional structural support for the longer shaft.

In another embodiment, the modification includes placing the orbital channels in the rotary weight and the plurality of pins relocated to the weighted rotor instead.

In another embodiment, two arms extending from a central hub, each with one orbital channel and a weighted rotor riding on the arms can be put to use. The same approach applies to three arms or a larger plurality of arms with orbital channels in each arm is also suitable for application.

In another embodiment, a plurality of arms extending from a central hub with a rim attached on the arm outer end. A plurality of orbital channels in the rim will provide the functional support to carry a rotary weight to produce unbalanced centrifugal forces for propulsion.

In the embodiments of the rotary weight shown in the drawings herein, the weight and the pins are shown as two members. However, at the time of manufacturing, the pins can be eliminated by manufacturing the weight with pins like projections.

In another embodiment, the function of the orbital channels is to provide a functional means of operation to maintain the uniform rotary motion of the eccentrically driven weight. As the weight riding on the weighted rotor gyrates about the weight eccentric axis of gyration, the weight would have a tendency to spin and move sideways simultaneously. The orbital channels operate to eliminate the sideways motion while keeping the rotary motion only. Similar in function to a channel, an arm attached to a pin is also applicable. An annular channel has a center. One end of the arm would be suitable attached to the proposed center of the channel, and the other end to the pin to the weight. Several arms, each attached to a corresponding pin in the weight can substitute for a channel. As the weight gyrates, the arm pull and push the weight at the proper interval in a cycle of revolution to transport the weight with the rotor. A plurality of arms, are a suitable replacement for a plurality of orbital channels.

Another embodiment consist in employing two (2) inertial thrust engines side by side or one on top of the other rotating in opposite directions in order to cancel out each other gyroscopic moments.

In the embodiments of the inertial thrust engine herein, the rotary weight engages the weighted rotor by way of a plurality of pins. Even though the pins shown are cylindrical in shape, other embodiments of the pin are also useful. For example, one useful improvement on the pin shape consists of modifying the projection part of the pin engaging the channel. Instead of an all cylindrical body projection in the channel, an arched projection with a similar curvature as the channel walls and with sufficient angular length can be employed to engage the channel and simultaneously enlarge the surface to surface contact between the channel and the pin; resulting in an improved rotary energy and centrifugal force transfer between the rotor and the weight. Moreover, the pins can be made longer than the depth of the channel to allow the weight to float above the weighted rotor surface.

As disclosed herein, an inertial thrust engine is a propellantless prime mover useful for the propulsion of land motor vehicles such as railway cars, passenger cars, buses, trucks, and vans. The application of an inertial thrust engine for on land propulsion can be used to add to the propulsion power of the vehicle in conjunction with the traction of the wheels. An inertial thrust engine can also be used as an added propulsion source to add to the total propulsive thrust, or to completely eliminate the need for a drive train. The use of inertial propulsion will improve and increase the miles per gallons of the land motor vehicle.

In aviation, a propellantless inertial thrust engine is useful for the propulsion of manned and unmanned aircrafts and related aerospace vehicles. Instead of propeller or jet power, an inertial thrust engine with a turbo shaft or an internal combustion engine is useful as a replacement of current propulsion technology engines. As an added benefit, the inertial thrust engine will deliver a considerable reduction in fuel consumption to increase the aircraft's performance with the added benefit of a decrease in the cost of aircraft operations.

Another application relevant to aerospace vehicles is the development of new lift and thrust platforms based on the technology of inertial thrust engines. For example, a singular or several inertial thrust engines oriented vertically can be employed to generate propulsive levitation lift and vectored thrust. In the horizontally position, an inertial thrust engine can provide vectored thrust for motion and direction control. The combination of vertical and horizontal inertial thrust engines will provide a full three dimensional lift and thrust vector control for aerospace vehicle applications.

In the field of naval ship operations, an inertial thrust engine is useful as a ship propulsion engine. Instead of the traditional marine propeller, an inertial thrust engine can perform the task without the added turbulence and losses of propellers. In submarines, the elimination of the propeller will yield a high considerable reduction in submarine noise, drag, and a reduction in fuel consumption due to improved propulsion efficiency.

In the field of space exploration, an inertial thrust engine has the obvious advantage that it produces thrust for propulsion without a propellant. In space travel, a self contained inertial thrust engine can operate with an electric motor and electricity produced solar cells and photons from the sun and nearby stars, or from an onboard electric power plant. Additionally, these same advantages also translate to the operation of satellites far out into space or in orbit around the earth and other planets.

In the above descriptions and explanations provided herein, the reader will see that an inertial thrust engine is a novel and efficient propellantless prime mover. The above description contains many specificities and illustrations of some of the presently preferred embodiments. The explanations herein should not be construed as limits on the scope and range of the invention. The disclosed specificities are not self imposed limitations and boundaries beyond not to be excelled. There are additional variations, derivatives, combinations, and ramifications beyond those illustrated in the text.

I claim:

1. A propulsion device comprising a housing, a weight for producing centrifugal forces, a rotary carrier to convey rotary energy to said weight, means for placing said weight eccentrically disposed on said carrier, whereby the rotary motion of said carrier with said weight generates an unbalanced centrifugal force for propellantless propulsion.

2. A propulsion device comprising a housing, a disk shaped weight for producing centrifugal forces, a rotary carrier to convey rotary energy to said weight, means for placing said weight eccentrically disposed on said carrier, whereby the rotary motion of said carrier with said weight generates an unbalanced centrifugal force for propellantless propulsion.

3. A propulsion device comprising a housing, an annular weight for producing centrifugal forces, a rotary carrier to convey rotary energy to said weight, means for placing said weight eccentrically disposed on said carrier, whereby the rotary motion of said carrier with said weight generates an unbalanced centrifugal force for propellantless propulsion.

4. A propulsion device comprising a housing, a weight for producing centrifugal forces, a weighted rotor for conveying rotary energy to said weight, a chamber for placing said weight eccentrically disposed on said rotor, whereby the rotary motion of said rotor and said weight generates a propellantless propulsion force.

5. A propulsion device comprising a housing, a disk shaped weight for producing centrifugal forces, a weighted rotor for conveying rotary energy to said weight, a chamber for placing said weight eccentrically disposed on said rotor, whereby the rotary motion of said rotor and said weight generates a propellantless propulsion force.

6. A propulsion device comprising a housing, a rotary annular weight for producing centrifugal forces, a weighted rotor for conveying rotary energy to said weight, a chamber for placing said weight eccentrically disposed on said rotor, whereby the rotary motion of said rotor and said weight generates a propellantless propulsion force.

7. A method for propulsion, comprising:
providing a weight for producing centrifugal forces,
providing a rotary means to convey rotary energy to said weight,
providing means to dispose eccentrically said weight on said rotary means,
whereby the rotary motion of said weight eccentrically disposed on said rotary means generates a propellantless propulsion force.
